(19) United States
(12) Patent Application Publication
(10) Pub. No.: US 2008/0104239 A1
(43) Pub. Date: May 1, 2008

(54) METHOD AND SYSTEM OF MANAGING ACCOUNTS BY A NETWORK SERVER

(76) Inventors: Greg J. LIPINSKI, Loveland, CO (US); Philip M. Walker, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/553,641

(22) Filed: Oct. 27, 2006

(51) Int. Cl. G06F 15/16; G06F 15/173

(52) U.S. Cl. 709/225; 709/203; 709/223

(57) ABSTRACT

Methods and systems of managing accounts by a network server. At least some of the illustrative embodiments are network server devices comprising a processor, and a non-volatile storage device coupled to the processor. The network server device does not support a directly coupled display device. The processor receives account information regarding existing user accounts on a computer system within the network, and the processor performs account management on the network server device using the account information received.

### BACKGROUND

Network attached storage (NAS) devices are computer systems with non-volatile storage (e.g., hard drives) where the non-volatile storage is accessible from any computer system in the network, in most cases a home network. Some NAS devices implement fault tolerant technologies, such as implementing a redundant array of inexpensive (or independent) devices (RAID) system. In addition to non-volatile storage capabilities, some NAS devices also act in other capacities, such as being the portal through which a user may connect to any computer system in the home network from external devices (e.g., connect to the home network from an office computer). For security reasons, in connecting from external devices login names and passwords are used.

In large corporate networks utilizing domain servers, authentication of a user (verifying the login name and password) is performed by the domain server, with the remote computer system acting merely as an intermediary for the user to provide the login name and password to the domain server. In home environments that do not use a domain server, authentication of a user is performed at each local machine to which the user attempts to login. When using a NAS device as a portal to connect to other computer systems in the home network, duplication of and administration of the accounts and passwords as between the computer systems and the portal device is cumbersome.

### BRIEF DESCRIPTION OF THE DRAWINGS

For a detailed description of exemplary embodiments of the invention, reference will now be made to the accompanying drawings in which:

FIG. 1 shows a home networking system in accordance with at least some embodiments,

FIG. 2 shows a home network server;

FIG. 3 shows a method in accordance with some embodiments; and

FIG. 4 shows a method in accordance with some embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to. . . . ”

Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

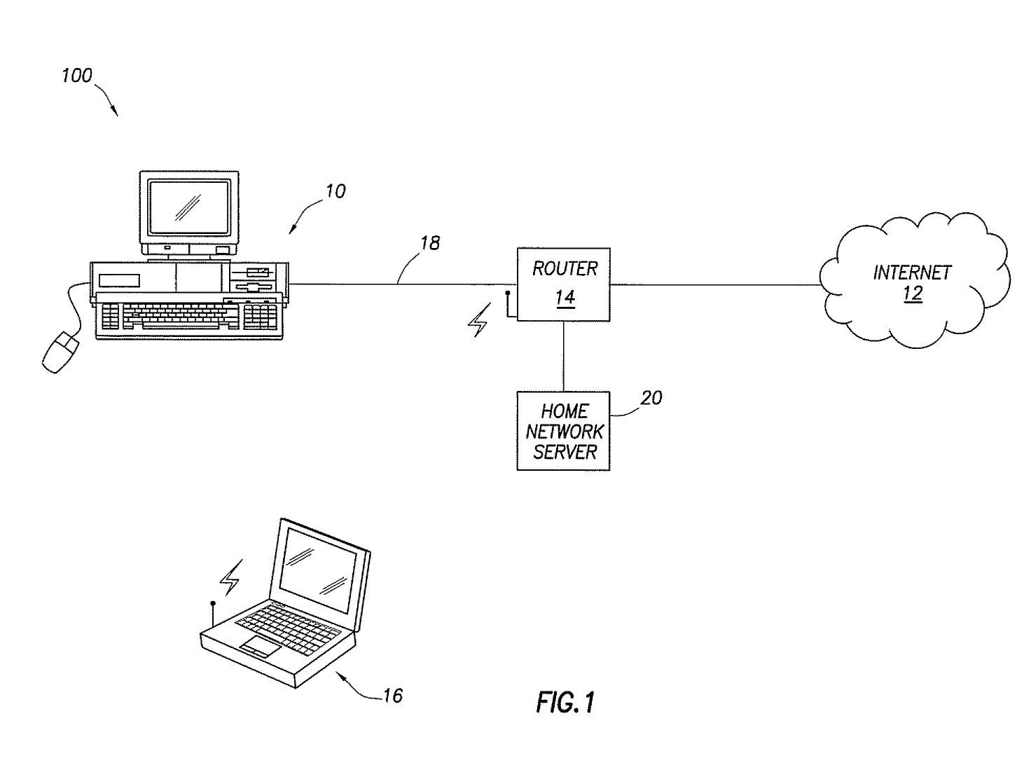

FIG. 1 illustrates a home networking system 100 in accordance with at least some embodiments. In particular, the home networking system 100 comprises an illustrative desktop computer system 10 coupled to the Internet 12 by way of a router 14. The home networking system 100 also comprises a second computer system, in this case a notebook computer system 16 coupled to the Internet 12 by way of the router 14. In the embodiments illustrated in FIG. 1, desktop computer system 10 couples to the router by way of a hardwired connection 18 (e.g., an Ethernet connection) and illustrative notebook computer system 16 couples to the router 14 wirelessly (e.g., IEEE 802.11, Bluetooth). However, computer systems may couple to the router in a hardwired fashion and/or wirelessly without regard to their portability. Further, while the system 100 of FIG. 1 shows only one desktop computer system 10 and one notebook computer system 16, any number of computer systems may be coupled to the router using any networking functionality.

The home networking system 100 of FIG. 1 also comprises a home network server 20 coupled to the router 14. The home network server 20 is a storage device and/or server available to any computer system of the home networking system 100 (e g, desktop computer system 10 or notebook computer system 16). The home network server 20 may be, for example, the central repository for data generated by computer systems of the home networking system 100. In the embodiments illustrated in FIG. 1, the storage implemented by home network server 20 is accessible to other computer systems of the home networking system by way of any suitable currently available networking communication protocol (e.g., Internet Protocol (IP), Transmission Control Protocol/Internet Protocol (TCP/IP), server message block (SMB)/common internet file system (CIFS)), or any after-developed networking protocol. Thus, the home network server 20 operates, at least in part, as a network attached storage (NAS) device.

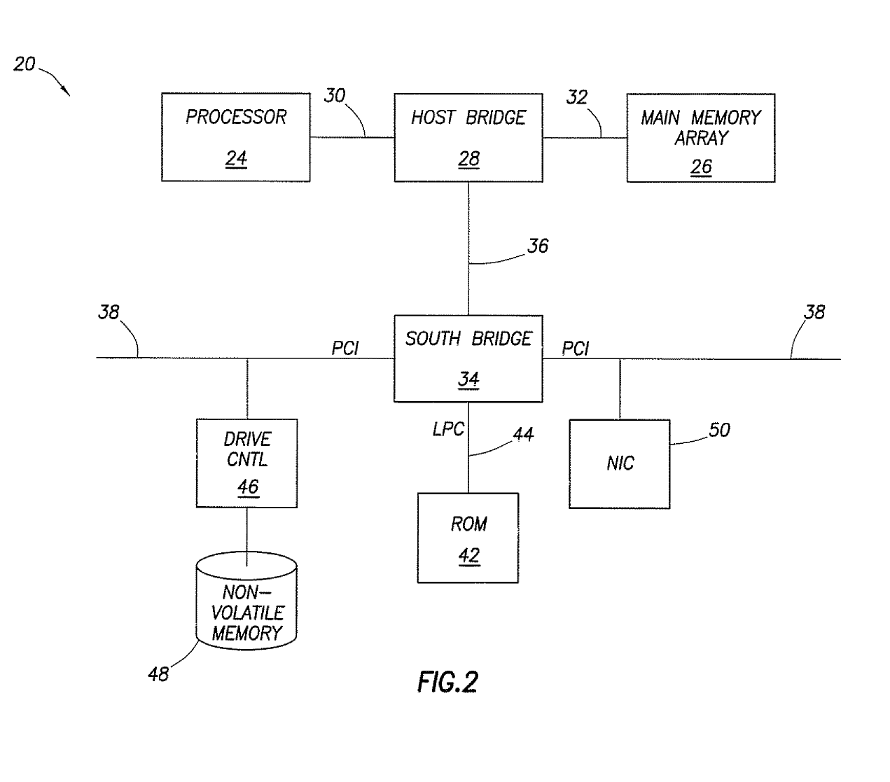

FIG. 2 illustrates in greater detail an embodiment of the home network server 20. In particular, home network sever 20 comprises a processor 24 coupled to a main memory array 26 and various other components through host bridge 28. The processor 24 couples to the host bridge 28 (sometimes referred to as a north bridge) by way of a host bus 30, or the host bridge 28 may be integrated into the processor 24. The processor 24 may be one of many available processors, and thus the home network server 20 may implement other bus configurations or bus-bridges in addition to, or in place of, those shown in FIG. 2.

Main memory array 26 couples to the host bridge 28 through a memory bus 32. The host bridge 28 comprises a memory control unit that controls transactions to the main memory 26 by asserting control signals for memory accesses. The main memory array 26 functions as the working memory for the processor 24 and comprises a memory device or array of memory devices in which programs, instructions and data are stored. The main memory array 26 may comprise any suitable type of memory such as dynamic random access memory (DRAM) or any of the various types of DRAM devices such as synchronous DRAM (SDRAM), extended data output DRAM (EDODRAM), or Rambus DRAM (RDRAM).

Still referring to FIG. 2, the home network server 20 also comprises a second bridge 34 that bridges the primary expansion bus 36 to various secondary expansion buses, such as the peripheral component interconnect (PCI) bus 38 and the low pin count (LPC) bus 44. The second bridge 34 may be referred to as the “south bridge” because of its location in computer system drawings Read only memory (ROM) 42 couples to the south bridge 34, such as by the LPC bus 44. The ROM 42 contains software programs executable by the processor 24 to enable the computer system components to perform tasks such as acting as a network attached storage device, and to implement user account management (discussed more below).

The home network server 20 further comprises a drive controller 46 coupled to the south bridge 34 by way of the illustrative PCI bus 38. In alternative embodiments, the drive controller may couple to the primary expansion bus 36, or any other currently available or after-developed expansion bus. The drive controller 46 controls the non-volatile memory 48, such as a hard drive or optical drive. In some embodiments, the home network server 20 implements a single hard drive where computer systems of the home network can store and retrieve data and programs. In alternative embodiments, the home network server 20 implements a redundant array of independent (or inexpensive) devices (RAID) system where the data and instructions written to the home network server are duplicated across multiple hard drives to implement fault tolerance.

Also coupled to the illustrative PCI bus 38 is a network interface card (NIC) 50. In alternative embodiments, the functionality of the NIC 50 is integrated onto the motherboard along with the bridges 28 and 34. Regardless of the precise location where the NIC is implemented, the NIC 50 enables the home network storage 20 to communicate with other computer systems on the home networking system 100 (through the router 14 of FIG. 1) such that the home network server can acts as a NAS device and also to manage user account information.

Because the home network server 20 is designed to act as a server for the home networking system 100, and possibly to reduce cost, in accordance with at least some embodiments the home network server 20 does not support direct coupling of a display device and/or keyboard. Thus, in some embodiments a home network sever 20 does not implement a graphics controller that would couple to a display, and also does not implement an input/output (I/O) controller that would couple to I/O devices such as a keyboard and mouse. To the extent administration is performed on the home network server 20, the administration may be accomplished remotely using other computer systems (e.g., desktop computer system 10 or notebook computer system 16) in the home networking system 100.

In accordance with embodiments, each computer system 10, 16 in the home networking system 100 has the capability to utilize user accounts comprising login names and passwords. The accounts are local to the respective computer systems 10, 16, and any similarity between accounts on different computer systems 10, 16 is based on independent creation of the corresponding accounts on the separate computer systems. The home network server 20 also has the capability to utilize account information. With the home network server 20 acting as a network attached storage device, the account information may limit access, in whole or in part, to the home network server by particular home users. For example, a parent login may provide access to portions of the storage on the home network server that is not available with a child login. Alternative embodiments enable persons with existing accounts on the home network server 20 to access the home network server from locations outside the home (edge, from the office over the Internet 12). Accessing the home network server 20 may be to obtain data stored on the home network server 20, and in some embodiments the home network server 20 acts as a portal through which any other computer system in home networking system may be reached from the external connection.

Consider a situation where a home networking system 100 exists, but initially without the home network server 20. Further consider that a user of the notebook computer system 16 creates a login name and selects a password to control access to the notebook 16. The act of creation of the login name and a password does not create a complementary account on the desktop computer system 10. In order for the user to have an account on the desktop computer system, such account information needs to be separately created on the desktop computer system 10. Moreover, the accounts for the particular user as between the notebook computer system 16 and the desktop computer system 10 are not constrained in this situation to have the same login name and password, and thus the user may have multiple login names and corresponding sets of passwords to access the computer systems in the home network.

Now consider that the home networking system 100 has a home network server 20. If the home network server 20 limits access to its internal storage, and also authenticates connections to the home networking system 100 from external locations, the home network server 20 also uses account information for each user. While it is possible to independently create account information for each user of the home networking system 100 on the home network server 20, such a situation leads to burdensome administration and the possibility of having different login names and/or passwords for each computer system 10, 16 and home network server 20.

In order to address account information administration in the home networking system 100, the user accounts existing on computer systems 10, 16 are automatically and transparently duplicated on the home network server 20. Moreover, in some embodiments the home network server 20 captures password changes in computer systems 10, 16, and updates the passwords for corresponding login names in the home network server 20 and other computer systems 10, 16 in the home networking system 100. In yet still other embodiments, the home network server 20 automatically manages user accounts such that any account created on any computer system 10, 16 is not only automatically created on the home network server 20, but also is (optionally) automatically created on each every computer system 10, 16 in the home networking system 100. In this way, a user may perform a login on any computer system in the home networking system 100 after having created account information on only one computer system.

Automatic creation of user accounts on the home network server 20 may take many forms. Consider first a situation where a home network server 20 is being newly installed in a home networking system 100. In these embodiments, a portion of the installation procedure may involve installing software on each of the computer systems 10, 16. The software installed on each computer system 10, 16 searches the computer system on which it is installed to identify user accounts. In some embodiments each user account found on the computer system is automatically created on the home network server 20, such as by a remote procedure call from the computer system 10, 16 to the home network server 20. In other embodiments, during the installation process the person performing the installation is given the option to select which accounts found on the computer system should be created on the home network server 20. For each account selected by the person performing the installation, a corresponding account is created on the home network server 20, again such as by a remote procedure call.

In some computer systems, passwords associated with login names are unrecoverable. For example, the Windows® operating system available from Microsoft® of Redmond Wash. may be configured such that passwords are unrecoverable. However, in other computer systems the passwords are recoverable. Again, for example, the Window® operating system may be configured such that passwords are recoverable. In operating systems where the passwords are discoverable or recoverable, the portion of the software installed on the computer system 10, 16 also finds the passwords for each login name, and forwards the passwords along with the login names to the home network server 20. The home network server 20, in turn, creates corresponding login names and passwords on the home network server 20.

In situations where passwords are not recoverable or cannot be found, the various embodiments still create corresponding accounts on the home network server 20, but the software installed on the computer system 10, 16 has further work to perform. In particular, in the embodiments where the password cannot be discovered, the software installed on the computer system 10, 16 may prompt the administrator for the passwords, or the software installed on the computer systems 10, 16 remains resident in the computer system and monitors keyboard activity for attempted logins. When a login is detected, the password for the login is noted and forwarded to the home network server 20, such as by an encrypted connection. The home network server 20 then modifies the password associated with the account such that the passwords as between computer system 10, 16 and the home network server 20 are the same. To the extent that the home network server 20 manages accounts on the other computer systems in the home networking system 100, the home network server 20 communicates with other computer systems on the home networking 100 and ensures that the password associated with corresponding login names on the other computer systems correspond.

In embodiments where login names and/or passwords are discovered by monitoring keystrokes of the keyboard, the keystrokes may be temporarily stored in a volatile memory (e.g., RAM) before being sent to the home network server 20. The recorded keystrokes are lost when power is removed, thus lessening the chances of the login names and/or passwords being discovered by malicious programs. After being forwarded to the home network server 20, the recorded keystrokes can be discarded and/or overwritten. In yet still further embodiments, the recorded keystrokes can be encrypted during the temporary storage in the volatile memory, thus further lessening the chances of malicious programs discovering the login names and/or passwords.

In yet still further embodiments, the software on the computer system 10, 16 used initially to configure the home network server 20 remains resident in the computer system and monitors for further account creation and password changes. When a new user account is created, or when a user changes the password for an existing account, the new account and/or password change information is communicated to the home network server 20, such as by an encrypted communication. The home network server 20 creates a corresponding account (if the user created a new account), or changes the password on the existing user account. Moreover, in embodiments where the home network server 20 propagates login names and passwords to other computer systems on the home networking system 100, the home network server 20 communicates the new account information and/or the updated password to the other computer systems in the home network 100. In this way, the user need only create the new account and/or change the password on a single computer system in the home networking system 100, and new accounts and/or passwords are communicated to all the other computer systems in the home networking system 100, with the creation and management on the other computer systems without user interaction.

In accordance with at least some embodiments, the home networking system 100 comprising the home network server 20 provides single point authentication for the entire home network. For example, a user performs a login on one of the computer systems 10, 16. If the login to the computer system 10, 16 is successful, software operating on the computer system (possibly installed during the installation procedure) automatically and transparently performs a login operation on the home network server 20, such as by a remote procedure call. Moreover, the home network server 20 provides access to other computer systems in the home network from a single computer system. When providing access to other computer systems, the home network server 20 automatically and transparently performs login operations on the further computer systems, again possibly by remote procedure calls. For example, a user may perform a login on notebook computer system 16, and as discussed above the software on the notebook computer system 16 automatically and transparently performs the login on the home network server 20. However, the user may need a file or need to run a program on the desktop computer system 10. The home network server 20 in accordance with these embodiments automatically and transparently performs a login operation on the desktop computer system 10, and enables the notebook computer system 16 user to reach files or to instantiate programs on the desktop computer 10.

Further still, the home network server 20 enables access to computer systems 10, 16 from computer systems external to the home network system 100, such as from an office computer coupled to the home network 100 over the Internet 12. In these embodiments, the person seeking remote access performs a login to the home network server 20 using the login name and password used when logging directly into the computer systems 10, 16. Once authenticated by the home network server 20, the home network server 20 enables the person seeking remote access the ability to choose which of the computer systems 10, 16 to which to connect, such as by showing Icons for each computer system 10, 16. Once a particular computer system 10, 16 is selected, the home network server automatically and transparently authenticates the user on the desired computer system, and then acts as a portal to the desired computer system. In some embodiments, if the desired computer system 10, 16 is powered-off, the home network server 20 wakes the desired computer system, such as by sending a wake command over the local area network connection (otherwise known as a wake on LAN command).

FIG. 3 illustrates a method (e.g., software) that may be performed on a computer system 10, 16 of the home networking system 100. In particular, the method starts (block 300) and proceeds to obtaining account information regarding the user accounts (block 304). The account information may be, for example, login names and passwords. In some embodiments, the login names and passwords may be by prompting the installing administrator. In other embodiments, the login names and passwords may be determined by scanning system files of the computer system 10, 16. In other embodiments, the login names may be determined by scanning the system files, and the passwords determined by recording keystrokes during a user login process. Regardless of the precise mechanism by which the account information is obtained, in some embodiments the user is queried as to whether to create corresponding accounts on the home network server 20 (block 308). If at least one account is to be created on the home network server 20 (block 312), a connection is established with the home network server 20 (block 316). In some embodiments, the connection is an encrypted connection. After establishing the connection, the account information for selected accounts is forwarded to the home network server 20 (block 320) so the home network server 20 can perform account management. Thereafter the process ends (block 324). In alternative embodiments, the querying (of block 312) may be omitted, and all the account information forwarded to the home network server 20. On the other hand, if the user elects not to create any accounts on the home network server 20 from the account information (again block 312), the process ends (block 324).

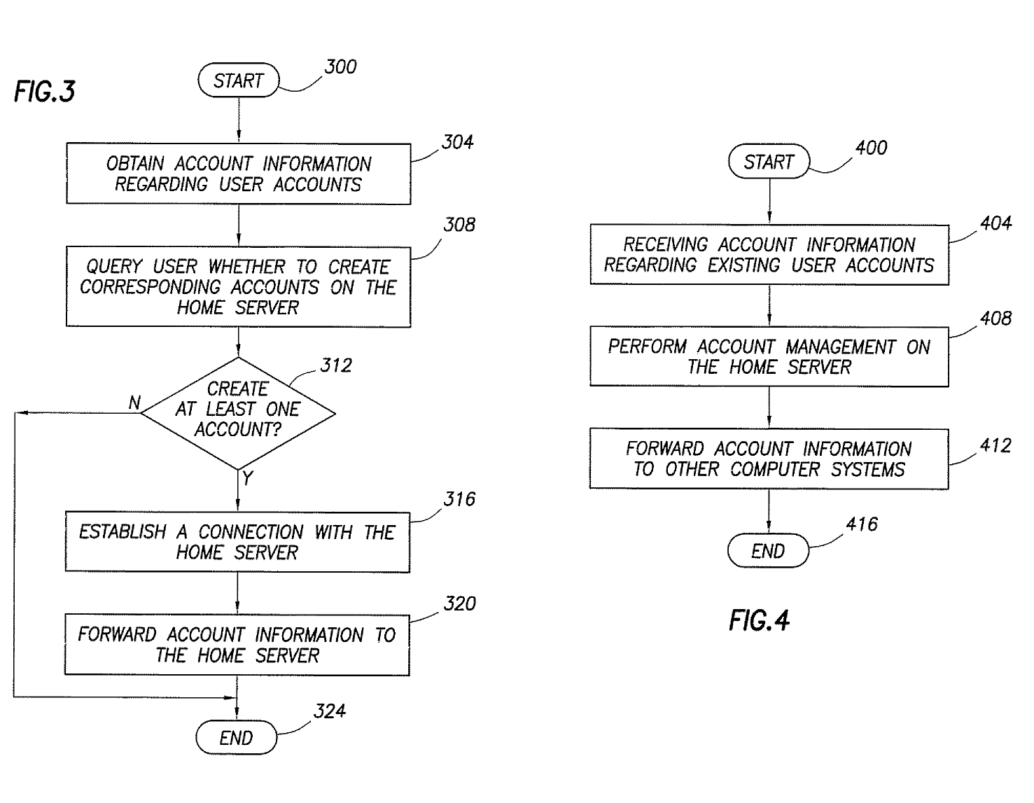

FIG. 4 illustrates a method (e.g., software) that may be performed on the home network server 20. In particular, the method starts (block 400) and proceeds to receiving account information regarding existing user accounts on the computer systems of the home networking system (block 404). Using the account information, the method performs account management on the home network server (block 408) and the process ends (block 412). The type of account information received varies. For initial setup, the account information may be login names and passwords, or just login names when passwords cannot be immediately determined by portions of the software executing on the computer systems 10, 16. At other times, the account information received may be new account information, newly captured passwords, or changed passwords captured when a user changes passwords on a particular computer system 10, 16.

After receiving account information, performance of account maintenance may be performed using the account information (block 408). The type of account maintenance is dependent upon the type of information received. When new account information is received, corresponding accounts are created on the home network server 20. When password information for existing accounts is the received account information, the passwords for the corresponding accounts on the home network server 20 are changed to match. In some embodiments, the home network server 20 forwards the account information to other computer systems in the home networking system (block 412), such that those other computer systems can modify their user account information to match such that login names and passwords are uniform throughout the home networking system. Thereafter, the process ends (block 416).

The above discussion is meant to be illustrative of the principles and various embodiments of the present invention. Numerous variations and modifications will become apparent to those skilled in the art once the above disclosure is fully appreciated. For example, the home networking server can operate with any currently available (e.g., Windows® or Linux), or after-developed operating system. Further, while the various embodiments are described in the context of a home networking system and a home server, the various embodiments are applicable to other environments as well. With respect to account management, account manage could be any task dealing with user/administrator accounts, such as at least one of: account creation on any computer system of the home networking system; account deletion on any computer system of the home networking system; ensuring that passwords among the various computer systems for particular accounts match; propagating changed passwords; or changing access permissions for various accounts

What is claimed is:

1. A computer-readable medium storing a program that, when executed by a processor, causes the processor to:
obtain account information regarding user accounts, the user accounts on a computer system in which the processor resides;
establish a connection with a server device;
forward the account information to the server device to perform account management on the server device.

2. The computer-readable medium as defined in claim 1 wherein when the processor obtains the account information, the program causes the processor to search the computer system for established accounts.

3. The computer-readable medium as defined in claim 1 wherein when the processor obtains the account information, the program causes the processor to record keystrokes when a user of the computer system logs into the computer system.

4. The computer-readable medium as defined in claim 3 wherein when the processor records the keystrokes, the program causes the processor to at least one selected from the group consisting of: temporarily store the keystrokes in un-encrypted form in a volatile memory; or temporarily store the keystrokes in encrypted form in the volatile memory.

5. The computer-readable medium as defined in claim 1 wherein when the processor obtains the account information, the program causes the processor to obtain user login names and user passwords.

6. The computer-readable medium as defined in claim 1 wherein when the processor establishes a connection with the server device the program causes the processor to establish an encrypted connection.

7. The computer-readable medium as defined in claim 1 wherein the program further causes the processor to:
query the computer system user whether to create at least one corresponding account on the server device; and
establish the connection and forward the account information only if the user indicates a desire to create the at least one corresponding account on the server device.

8. The computer-readable medium as defined in claim 1 wherein when the processor obtains the account information the program causes the processor to obtain an updated password for an existing login name.

9. A computer-readable medium storing a program that, when executed by a processor of a server device, causes the processor to:
receive account information regarding user accounts on a computer system within a network; and
perform account management on the server device using the account information received.

10. The computer-readable medium as defined in claim 9 wherein when the processor receives account information the processor receives account information being a login name and password.

11. The computer-readable medium as defined in claim 9 wherein when the processor performs account management the program causes the processor to create an account using the account information.

12. The computer-readable medium as defined in claim 11 wherein when the processor creates the account the program causes the processor to create an account having the same login name and password as used on the computer system within the network.

13. The computer-readable medium as defined in claim 9 further comprising:
wherein when the processor receives the account information the processor receives an updated account password from the computer system;
wherein when the processor performs the account management the program causes the processor the updated the account password on the server device.

14. The computer-readable medium as defined in claim 13 wherein when the processor performs the account management the program causes the processor to send the updated account password to other computer systems in the network.

15. A network server device comprising:
a processor;
a non-volatile storage device coupled to the processor;
said network server device does not support a directly coupled display device;
said processor receives account information regarding existing user accounts on a computer system within the network, and the processor performs account management on the network server device using the account information received.

16. The network server device as defined in claim 15 wherein when the processor performs account management the processor creates an account using the account information.

17. The network server device as defined in claim 16 wherein when the processor creates the account the processor creates the account having the same login name and password as used on the computer system within the network.

18. The network server device as defined in claim 15 further comprising:
wherein when the processor receives the account information the processor receives an updated account password from the computer system; and
wherein when the processor performs the account management the processor updates the account password on the network server device.

19. The network server device as defined in claim 18 wherein when the processor performs the account management the processor sends the updated account password to other computer systems in the network.

20. The network server device as defined in claim 15 further comprising:
said processor authenticates a connection to the network server from a device external to the network; and
said processor enables the connection from devices external to reach computer systems of the network.

21. The network server device as defined in claim 15 wherein the processor wakes a particular computer system in the network if the connection attempts to reach the particular computer system in a powered-off condition.
